(19) United States
(12) Patent Application Publication
(10) Pub. No.: US 2023/0247416 A1
(43) Pub. Date: Aug. 3, 2023

(54) USER EQUIPMENT, BASE STATION AND METHOD PERFORMED BY THE SAME IN WIRELESS COMMUNICATION SYSTEM

(71) Applicant: Samsung Electronics Co., Ltd., Gyeonggi-do (KR)

(72) Inventors: Yiyan ZHANG, Beijing (CN); He Wang, Beijing (CN); Feifei Sun, Beijing (CN)

(21) Appl. No.: 18/098,955

(22) Filed: Jan. 19, 2023

(30) Foreign Application Priority Data
Jan. 28, 2022 (CN) 202210108438.6

(51) Int. Cl. H04W 8/22; H04W 24/02; G06N 20/00

(52) U.S. Cl. CPC H04W 8/22; G06N 20/00; H04W 24/02

(57) ABSTRACT

Disclosed are a user equipment (UE), a base station and methods performed by the UE and base station in a wireless communication system. The method performed by the UE in the wireless communication system includes receiving, from the base station, information on a machine learning algorithm and model; and performing at least one operation based on the received information.

### CROSS-REFERENCE TO RELATED APPLICATION(S)

This application is based on and claims priority under 35 U.S.C. §119 to Chinese Patent Application No. 202210108438.6, which was filed in the China Intellectual Property Office on Jan. 28, 2022, the entire disclosure of which is incorporated herein by reference.

### BACKGROUND

### 1. Field

The present disclosure relates to a user equipment (UE), a base station and a method performed by the UE or the base station in a wireless communication system and, more particularly, to a method and apparatus for implementing and applying a machine learning (ML) algorithm framework in the wireless communication system.

### 2. Description of the Related Art

Fifth generation (5G) mobile communication technologies define broad frequency bands such that high transmission rates and new services are possible, and can be implemented not only in sub 6 GHz bands such as 3.5 GHz, but also in above 6 GHz bands referred to as mmWave including 28 GHz and 39 GHz. In addition, it has been considered to implement sixth generation (6G) mobile communication technologies (referred to as beyond 5G systems) in terahertz bands (e.g., 95 GHz to 3 THz bands) to accomplish transmission rates that are fifty times faster than 5G mobile communication technologies and ultra-low latencies that are one-tenth of 5G mobile communication technologies.

Since the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input and multiple-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There has also been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks. Accordingly, it is expected that enhanced functions and performances of 5G mobile communication systems and integrated operations of connected devices will be necessary. To this end, new research is scheduled in connection with eXtended reality (XR) for efficiently supporting augmented reality (AR), virtual reality (VR), mixed reality (MR) and the like, 5G performance improvement and complexity reduction by utilizing artificial intelligence (AI) and ML, AI service support, metaverse service support, and drone communication.

Further, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to address at least the above-mentioned problems and/or disadvantages and to provide at least the advantages described below.

An aspect of the disclosure provides a method performed by a UE in a wireless communication system, the method including receiving information on an ML algorithm and model; and performing at least one operation based on the information.

Another aspect of the disclosure provides a UE in a wireless communication system that includes a transceiver and a processor that is coupled to the transceiver and is configured to receive information on a machine learning algorithm and model of the UE; and perform at least one operation based on the received information.

Preferably, the received information may comprise at least one of first information, second information, third information, fourth information, fifth information, sixth information, seventh information, and eighth information, and the at least one operation may comprise at least one of: based on the first information, reporting information on a machine learning algorithm and model used by the UE to the base station; based on the second information, reporting information on an acknowledgement of an activation of the machine learning algorithm and model of the UE to the base station; based on the third information, reporting information on an acknowledgement of an update of the machine learning algorithm and model of the UE to the base station; based on the fourth information, stopping one or more partial machine learning algorithms and models or terminating at least one machine learning algorithm and model; based on the fifth information, reporting information on reconfiguring the machine learning algorithm and model of the UE to the base station; based on the sixth information, reporting contents indicated by the sixth information to the base station; based on the seventh information, suspending the machine learning algorithm and model; and based on the eighth information, resuming the machine learning algorithm and model.

Preferably, the method may further include, based on the fourth information, partially stopping or completely terminating transmission of related data information on the machine learning algorithm and model, and transmitting to the base station information on an acknowledgement of partially stopping or completely terminating.

A further aspect of the disclosure provides a method performed by a base station in a wireless communication system, the method including transmitting information on a machine learning algorithm and model to a UE; and receiving a report regarding the machine learning algorithm and model from the UE.

An aspect of the disclosure provides a base station in a wireless communication system that includes a transceiver and a processor that is coupled to the transceiver and is configured to transmit information on a machine learning algorithm and model to a UE; and receive a report regarding the machine learning algorithm and model from the UE.

Preferably, the transmitted information may comprise at least one of first information, second information, third information, fourth information, fifth information, sixth information, seventh information, and eighth information, wherein receiving the report comprises: based on the first information, receiving information on a machine learning algorithm and model used by the UE; based on the second information, receiving information on an acknowledgement of an activation of the machine learning algorithm and model of the UE, based on the third information, receiving information on an acknowledgement of an update of the machine learning algorithm and model of the UE; based on the fourth information, receiving information on an acknowledgement of stopping one or more partial machine learning algorithms and models or terminating at least one machine learning algorithm and model; based on the fifth information, receiving information on reconfiguring the machine learning algorithm and model of the UE; based on the sixth information, receiving contents indicated by the sixth information; based on the seventh information, receiving information on an acknowledgement of suspending the machine learning algorithm and model; and based on the eighth information, receiving information on an acknowledgement of resuming the machine learning algorithm and model

Preferably, the first information may comprise at least one of: information for indicating at least one of a periodical report, a semi-statical report or an aperiodical report by the UE; information for indicating a task performed through machine learning; information for indicating reporting of capabilities of processing the machine learning algorithm and model; information for indicating reporting at least one of a status and a preference setting of the UE; and information for indicating reporting a service type or a traffic type of the UE.

Preferably, the information on the machine learning algorithm and model of the UE may comprise at least one of: information on a task performed through machine learning; information on capabilities of processing the machine learning algorithm and model; information on at least one of a status and a preference setting of the UE; and information on a service type or a traffic type of the UE.

Preferably, the second information may comprise at least one of: information for indicating a task to be implemented using the machine learning algorithm and model; information for a wireless communication device that executes the machine learning algorithm and model; information for indicating a periodic setting of information transmission between the UE and the base station; information for indicating that the information on the machine learning algorithm and model is transferred through at least one of a control channel and a data channel; information for indicating information on performance indicator transmission; and information for indicating at least one of a model configuration and a transmission configuration of the machine learning algorithm and model.

Preferably, the information on the acknowledgement of the activation of the machine learning algorithm and model may comprise at least one of: information on a model configuration of the machine learning algorithm and model; and information on performance of the machine learning algorithm and model

Preferably, the information for indicating the at least one of the model configuration and the transmission configuration of the machine learning algorithm and model may comprise at least one of: information on at least one of a model structure and a model parameter; and information on a transmission capability.

Preferably, the third information may comprise at least one of: information for indicating a model structure of the machine learning algorithm and model; information for indicating a model parameter of the machine learning algorithm and model; information for indicating at least one of an input data format, an output data format and a preference of the machine learning algorithm and model; and information for indicating a performance indicator of the machine learning algorithm and model

Preferably, the information on the acknowledgement of the update of the machine learning algorithm and model may comprise information on performance of the updated machine learning algorithm and model.

Preferably, the information on performance of the updated machine learning algorithm and model may comprise at least one of: information on a computational latency of the machine learning algorithm and model; and information on at least one of accuracy, precision and recall of the machine learning algorithm and model.

Preferably, the fifth information may comprise at least one of: information for indicating reconfiguration of the machine learning algorithm and model; and information for indicating a performance requirement for reconfiguring the machine learning algorithm and model.

Preferably, the information on reconfiguring the machine learning algorithm and model may comprise at least one of: information on a recommended updated machine learning algorithm and model; and information on at least one of a model structure, a model parameter, and a preference of the recommended updated machine learning algorithm and model.

Preferably, the sixth information may comprise at least one of: information on the contents; and information on at least one of a frequency and a period of reporting the contents.

Preferably, the contents may comprise at least one of: information on a state of the UE; information on performance of the machine learning algorithm and model; information on a data sample of the machine learning algorithm and model; and information on at least one of a suspending requirement and an update requirement for the machine learning algorithm and model.

Preferably, the task performed through machine learning may comprise at least one of: compression of channel state information; feedback of the channel state information; reconstruction of the channel state information; prediction of the channel state information; positioning of the UE; beam management of the base station; beam management of the UE; reference signal recovery for at least one of the base station and the UE; channel estimation for at least one of the base station and the UE; and nonlinear compensation of a power amplifier.

### BRIEF DESCRIPTION OF DRAWINGS

The above and/or additional aspects, features and advantages of certain embodiments of the present disclosure will become apparent and readily understood from the following description, taken in conjunction with the accompanying drawings, in which:

FIG. 1 illustrates a wireless network in accordance with various embodiments;

FIG. 2A illustrates a wireless transmit path in accordance with an embodiment;

FIG. 2B illustrates a wireless reception path in accordance with an embodiment;

FIG. 3A illustrates components of a UE according to an embodiment;

FIG. 3B illustrates components of a gNB according to an embodiment;

FIG. 4 illustrates switching between an ML state and a non-ML state by a UE and a base station in a wireless communication system according to an embodiment;

FIG. 5 illustrates a lifecycle of a UE and a base station in an ML state in a wireless communication system according to an embodiment,

FIG. 6 illustrates updating and reconfiguration of an ML algorithm and model in an ML state for a UE and a base station in a wireless communication system according to an embodiment;

FIG. 7 illustrates an internal transition relationship between states and among stages of an ML state and a non-ML state according to an embodiment;

FIG. 8 illustrates a method performed by the UE according to an embodiment;

FIG. 9 illustrates components of a UE in accordance with an embodiment; and

FIG. 10 illustrates components of a base station in accordance with an embodiment.

### DETAILED DESCRIPTION

The following description with reference to the accompanying drawings is provided to facilitate a comprehensive understanding of various embodiments of the present disclosure as defined by the claims and equivalents thereof. Those of ordinary skill in the art may recognize that various changes and modifications may be made to various embodiments described herein without departing from the scope and spirit of the present disclosure. In addition, description of well-known functions and constructions may be omitted for clarity and conciseness.

The terms and expressions used in the following description and claims are not limited to their dictionary meanings. Instead, they are used to provide a clear and consistent understanding of the present disclosure, as would be recognized by those skilled in the art.

It should be understood that the singular forms a, an, and the also include plural referents, unless the context clearly dictates otherwise. Thus, e.g., reference to a component surface includes reference to one or more of such surfaces.

The terms including or may include refer to presence of a correspondingly disclosed function, operation, or component that may be used in various embodiments of the present disclosure, rather than limiting presence of one or more additional functions, operations, or features. Further, the terms comprising or having may be interpreted to mean certain features, numbers, steps, operations, constituent elements, components, or combinations thereof, but should not be interpreted as excluding the possibility of existence of one or more other features, numbers, steps, operations, constituent elements, components, or a combination thereof.

The term or as used in various embodiments of the present disclosure includes any of the listed terms and all combinations thereof. For example, A or B may include A, may include B, or may include both A and B.

Unless otherwise defined, all terms (including technical or scientific terms) used in the present disclosure have the same meaning as understood by a person of ordinary skill in the art described in this disclosure. Common terms as defined in dictionaries are to be interpreted to have meanings consistent with the context in the relevant technical field, and should not be interpreted ideally or overly formalized, unless explicitly so defined in the present disclosure.

To meet the increasing demand for wireless data communication services since the deployment of fourth generation (4G) communication systems, efforts have been made to develop improved 5G or pre-5G communication systems. Therefore, 5G or pre-5G communication systems are also called beyond 4G networks or post-long term evolution (LTE) systems.

To achieve a higher data rate, 5G communication systems are implemented in higher frequency (e.g., millimeter wave) bands, e.g., 60 GHz bands. In order to reduce propagation loss of radio waves and increase a transmission distance, technologies such as beamforming, massive MIMO, FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

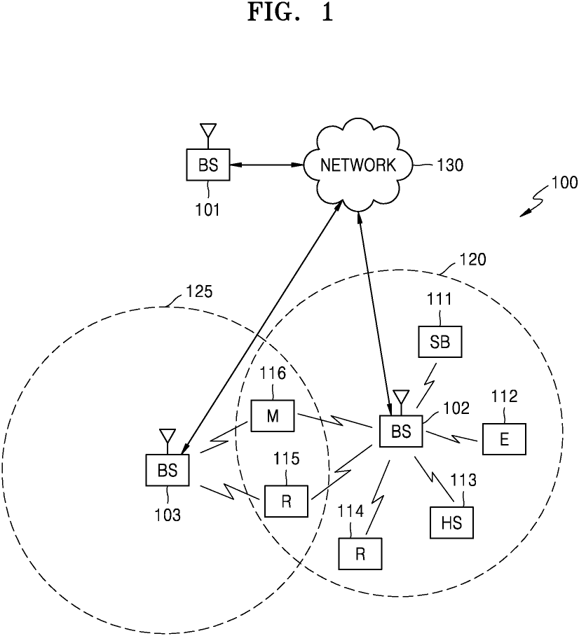

FIG. 1 illustrates an example wireless network 100 according to various embodiments The embodiment of the wireless network 100 shown in FIG. 1 is for illustration only. Other embodiments of the wireless network 100 may be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms such as base station or access point may be used instead of gNodeB or gNB. For convenience, the terms gNodeB and gNB refer to network infrastructure components that provide wireless access for remote terminals. And, depending on the type of the network, other well-known terms such as mobile station, user station, remote terminal, wireless terminal or user apparatus may be used instead of UE. For convenience, the term UE refers to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of UEs within a coverage area 120 of gNB 102. The first plurality of UEs include a UE 111, which may be located in a small business (SB); a UE 112, which may be located in an enterprise (E); a UE 113, which may be located in a WiFi hotspot (HS); a UE 114, which may be located in a first residence; a UE 115, which may be located in a second residence; a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 may communicate with each other and with UEs 111-116 using 5G, LTE, LTE-advanced (LTE-A), worldwide interoperability for microwave access (WiMAX) or other advanced wireless communication technologies.

The dashed lines in FIG. 1 show approximate ranges of the coverage areas 120 and 125, and the ranges are shown as approximate circles merely for illustration and explanation purposes. It should be understood that the coverage areas associated with the gNBs, such as the coverage areas 120 and 125, may have other shapes, including irregular shapes, depending on configurations of the gNBs and changes in the radio environment associated with natural obstacles and man-made obstacles.

As described herein, one or more of gNB 101, gNB 102, and gNB 103 include a two-dimensional (2D) antenna array as described in certain embodiments. In certain embodiments, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 may include any number of gNBs and any number of UEs in any suitable arrangement, for example. Further, gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, gNB 101, 102 and/or 103 may provide access to other or additional external networks, such as external telephone networks or other types of data networks.

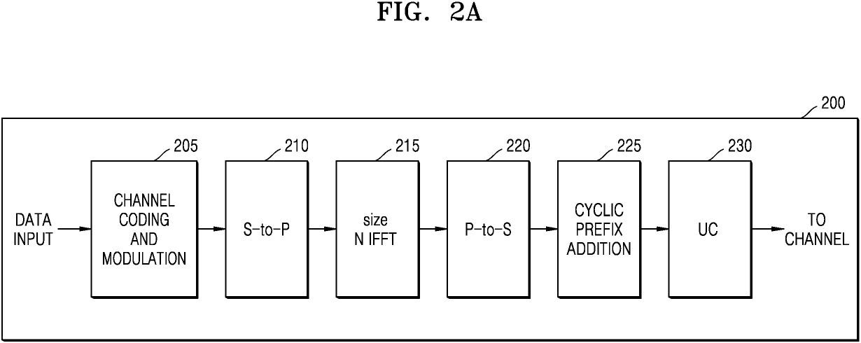

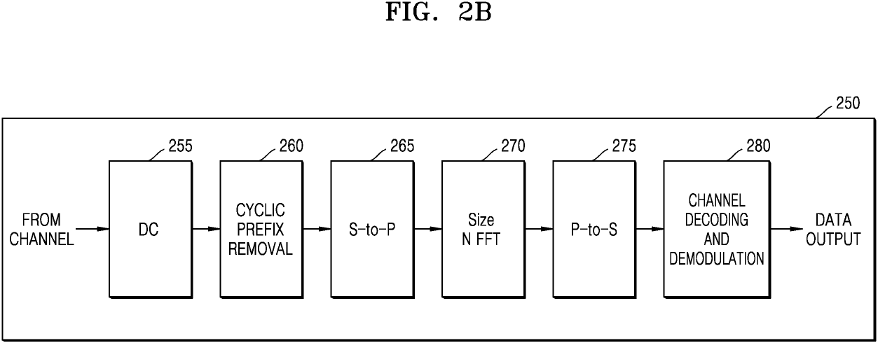

FIG. 2A illustrates a wireless transmit path in accordance with an embodiment. FIG. 2B illustrates a wireless reception path in accordance with an embodiment. In the description of FIG. 2A, the transmission path 200 may be described as being implemented in a gNB, such as gNB 102, and the reception path 250 of FIG. 2B may be described as being implemented in a UE, such as UE 116. However, it should be understood that the reception path 250 may be implemented in a gNB and the transmission path 200 may be implemented in a UE. In some embodiments, the reception path 250 is configured to support codebook designs and structures for systems with 2D antenna arrays as described in embodiments of the present disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, an S-to-P block 265, a size N fast Fourier transform (FFT) block 270, a P-to-S block 275, and a channel decoding and demodulation block 280.

In the transmission path 200, the channel coding and modulation block 205 receives a set of information bits, applies coding (such as LDPC coding), and modulates the input bits (such as using quadrature phase shift keying (QPSK) or QAM) to generate a sequence of frequency-domain modulated symbols. The S-to-P block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The P-to-S block 220 converts (such as multiplexes) parallel time-domain output symbols from the Size N IFFT block 215 to generate a serial time-domain signal. The cyclic prefix addition block 225 inserts a cyclic prefix into the time-domain signal. The UC 230 modulates (such as up-converts) the output of the cyclic prefix addition block 225 to a radio frequency (RF) for transmission via a wireless channel. The signal may also be filtered at a baseband before switching to RF.

The RF signal transmitted from gNB 102 arrives at UE 116 after passing through the wireless channel, and operations in reverse to those at gNB 102 are performed at UE 116. The DC 255 down-converts the received signal to a baseband frequency, and the cyclic prefix removal block 260 removes the cyclic prefix to generate a serial time-domain baseband signal. The S-to-P block 265 converts the time-domain baseband signal into a parallel time-domain signal. The size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement the reception path 250 for receiving from gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the size N FFT block 270 and IFFT block 215 may be implemented as configurable software algorithms, in which the value of the size N may be modified according to the implementation.

Although described as using FFT and IFFT, this is only illustrative and should not be interpreted as limiting the scope of the present disclosure. Other types of transforms may be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIG. 2A and FIG. 2B illustrate examples of wireless transmission and reception paths, various changes may be made to FIGS. 2A and 2B. For example, various components in FIGS. 2A and 2B may be combined, further subdivided or omitted, and additional components may be added according to specific requirements. FIG. 2A and FIG. 2B illustrate examples of types of transmission and reception paths that may be used in a wireless network, and any other suitable architecture may be used to support wireless communication in a wireless network.

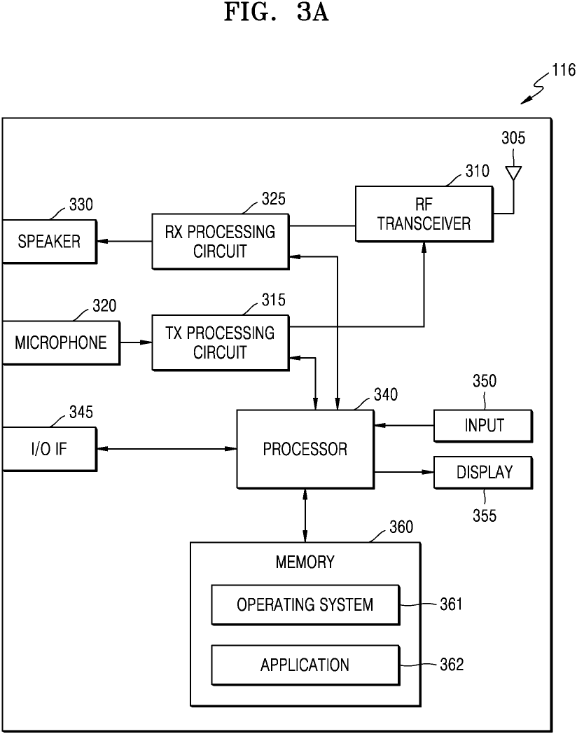

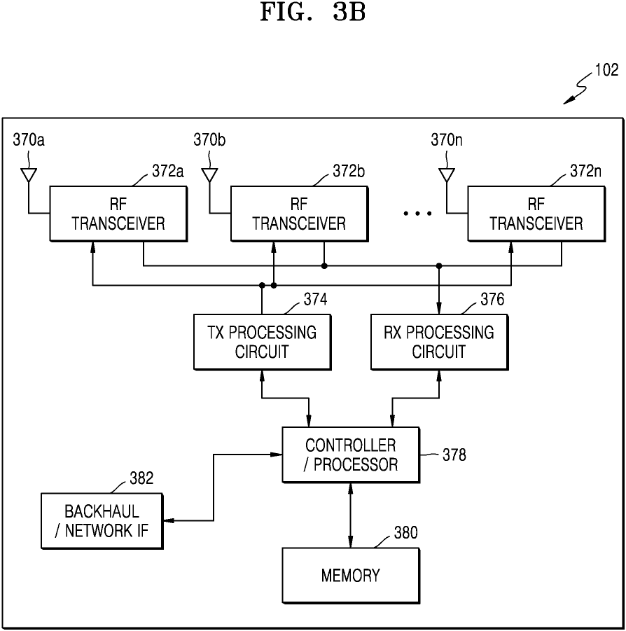

FIG. 3A illustrates components of a UE according to an embodiment. UE 116 shown in FIG. 3A is for illustration only, and UEs 111-115 of FIG. 1 may have the same or similar configuration . However, a UE has various configurations, and FIG. 3A does not limit the scope of the present disclosure to any specific implementation of the UE.

UE 116 includes an antenna 305, an RF transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to the speaker 330 (e.g., for voice data) or to the processor/controller 340 for further processing (e.g., for web browsing data).

The TX processing circuit 315 receives analog or digital voice data from the microphone 320 or other outgoing baseband data (e.g., network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of UE 116. For example, the processor/controller 340 may control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 may move data into or out of the memory 360 as required by an execution process. In some embodiments, the processor/controller 340 is configured to execute the one or more applications 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers The I/O interface 345 is a communication path between these accessories and the processor/controller 340.

The processor/controller 340 is also coupled to the input device(s) 350 and the display 355. An operator of UE 116 may input data into UE 116 using the input device(s) 350. The display 355 may be a liquid crystal display or other display capable of presenting text and/or at least limited graphics (such as from a website). The memory 360 is coupled to the processor/controller 340. A part of the memory 360 may include a random access memory (RAM), while another part of the memory 360 may include a flash memory or other read-only memory (ROM).

Although FIG. 3A illustrates an example of UE 116, various changes may be made to FIG. 3A. E.g., various components in FIG. 3A may be combined, further subdivided or omitted, and additional components may be added according to specific requirements. For example, the processor/controller 340 may be divided into a plurality of processors, such as one or more central processing units (CPUs) and one or more graphics processing units (GPUs). Further, although FIG. 3A illustrates that the UE 116 is configured as a mobile phone or a smart phone, UEs may be configured to operate as other types of mobile or fixed devices.

FIG. 3B illustrates components of a gNB according to an embodiment. gNB 102 shown in FIG. 3B is for illustration only, and other gNBs of FIG. 1 may have the same or similar configuration. However, a gNB has various configurations, and FIG. 3B does not limit the scope of the present disclosure to any specific implementation of a gNB. It should be noted that gNB 101 and gNB 103 may include the same or similar structures as gNB 102.

As shown in FIG. 3B, gNB 102 includes a plurality of antennas 370a, 370b ... 370n, a plurality of RF transceivers 372a, 372B ... 372n, a TX processing circuit 374, and an RX processing circuit 376. In certain embodiments, one or more of the plurality of antennas 370a, 370b ... 370n include a 2D antenna array. gNB 102 also includes a controller/processor 378, a memory 380, and a backhaul or network interface 382.

RF transceivers 372a, 372B ... 372n receive an incoming RF signal from antennas 370a, 370b ... 370n, such as a signal transmitted by UEs or other gNBs. RF transceivers 372a, 372B ... 372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (e.g., voice data, network data, email or interactive video game data) from the controller/processor 378. TX processing circuit 374 encodes, multiplexes and/or digitizes outgoing baseband data to generate a processed baseband or IF signal. RF transceivers 372a, 372B ... 372n receive the outgoing processed baseband or IF signal from TX processing circuit 374 and up-convert the baseband or IF signal into an RF signal transmitted via antennas 370a, 370b ... 370n.

The controller/processor 378 may include one or more processors or other processing devices that control the overall operation of gNB 102. For example, the controller/processor 378 may control the reception of forward channel signals and the transmission of backward channel signals through the RF transceivers 372a, 372B ... 372n, the RX processing circuit 376 and the TX processing circuit 374 according to well-known principles. The controller/processor 378 may also support additional functions, such as higher-level wireless communication functions. For example, the controller/processor 378 may perform a blind interference sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the present disclosure. In some embodiments, the controller/processor 378 supports communication between entities such as web RTCs. The controller/processor 378 may move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 may support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 may allow gNB 102 to communicate with other gNBs through wired or wireless backhaul connections. When gNB 102 is implemented as an access point, the backhaul or network interface 382 may allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 may include an RAM, while another part of the memory 380 may include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described herein, the transmission and reception paths of gNB 102 (implemented using RF transceivers 372a, 372B ... 372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 may include any number of each component shown in FIG. 3A. As a specific example, the access point may include many backhaul or network interfaces 382, and the controller/processor 378 may support routing functions to route data between different network addresses. As another specific example, although shown as including a single instance of the TX processing circuit 374 and a single instance of the RX processing circuit 376, gNB 102 may include multiple instances of each (such as one for each RF transceiver).

The embodiments of the present disclosure are further described below in conjunction with the accompanying drawings, with the same or similar reference numerals referring to the same or similar elements.

In a wireless communication system, during the communication between a base station at a network side and a wireless UE at a terminal side, an air interface needs to solve many problems in such communication process, such as pilot-based channel estimation by the UE, feedback of channel state information by the UE, beamforming and beam management for multi-antenna transmission and reception at the terminal side and network side, etc. The problems that need to be solved for such air interfaces are the classic problems that need to be solved in the wireless communication system, and after years of research, there are relatively mature solutions based on rules and procedures.

In recent years, AI technologies represented by deep learning (DL) algorithms have emerged again, solving the problems that have existed in all walks of life for many years, and achieving great technical and commercial success. With the continuous evolution of wireless communication systems, these problems in the air interface have been studied and new methods have been tried to be introduced to solve them. In recent years, many air interface related problems of wireless communication have been extensively studied with AI-based solutions, and some results are theoretically superior to traditional algorithms. In standardization discussions about the upcoming Rel-18 version of the 5G NR standardization organization 3GPP, AI-based physical layer wireless communication technologies are also widely discussed and may be written into the standard of 5G and/or 6G wireless communication technology in the future.

To solve some problems encountered in the communication process, an ML method is enabled, with the ML method usually refers to inclusion of design of the ML algorithm and design of a ML model on which the algorithm is based. The ML algorithm is divided into two different stages, namely a training phase and an inference phase. Generally, an ML model may first go through the training phase, in which a parameter weight in the ML model is learned according to a task target, the data for training provided in this phase may be obtained online or offline; and after completion of the training, the ML model may be used in the inference phase, in which tasks such as optimization, prediction, classification, and regression may be performed according to the result of model training. These two stages may be carried out independently and successively, or they may be carried out alternately

The solution based on the AI DL technology usually refers to an algorithm using the artificial neural network as a model in the ML technologies. The DL network model is usually composed of multi-layer stacked artificial neural networks, the weight parameter in the neural network is adjusted by training the existing data, and then used in the inference phase to achieve the purpose of the tasks in the unseen situation. Meanwhile, as compared with a general fixed rule-based solution or algorithm, the DL-based solution generally requires better computing capability than the original classical algorithm, which usually requires a dedicated computing chip in a device running the DL algorithm, to support the more efficient operation of the DL algorithm.

Problems encountered in the communication that are solved by the AI algorithm based on the ML usually need to meet the condition for ML problems. Among the existing problems related to the air interface in the communication, many problems such as channel information feedback, reference signal estimation, beamforming, and UE positioning, etc., all meet the condition to a certain extent, so the ML algorithm may be used to solve them, and achieve the better result than the traditional solution in the process of communication transmission

Although for the currently used wireless communication system, these algorithms may at times provide normal implementations and function. However, for the ML algorithms, due to their completely different architecture and characteristics from the traditional algorithm (such as including two different stages), use methods thereof are completely different from the traditional classical algorithms. As today’s wireless communication systems (e.g, 4G, 5G and possibly future 6G wireless communication systems) have strict and unified standards to limit the configuration method and behavior process of the air interface in the communication process. Thus, considering use of the new technologies of ML in the new generation of wireless communication system, design of the air interface must be combined with characteristics of new communication systems and ML algorithms. For implementation of ML-based algorithms in the air interface of the wireless communication system, it is necessary to specify the specific implementation process, how to transmit and interact a signal between the UE and the base station, and the process of activating and deactivating the ML algorithm and model, an update used in the ML algorithm and model, and the like, are the points needed to be considered.

Therefore, based on the above problems, in order to use ML-based solutions in wireless communication systems, it is necessary to provide an effective technical method to specify the specific methods for implementing these solutions in the system, processes that need to exist, and the like, to establish a suitable framework to solve the air interface related problem in the wireless communication with the ML-based method.

As used herein, the term ML algorithm and model may be used interchangeably with AI/ML based technologies, AI/ML for NR air interface, AI/ML technologies, AI/ML architecture, AI/ML model, AI/ML for air interface, AI/ML approaches, AI/ML related algorithms, AI/ML based algorithms and AI/ML scheme.

Provided herein are solutions for applying and configuring an ML-based algorithm and a model in a wireless communication system to complete or realize tasks or functions in an air interface of the wireless communication system. The solution includes, for example, stages of a base station and a UE in the wireless communication system in an ML state; behavior and processing flow of the base station and the UE in each of the stages; a relationship between different stages and internal transition. The present disclosure realizes application and configuration of an ML-based algorithm and model through a complete scheme design, improving transmission performance of the wireless communication system.

The present disclosure solves problems in air interfaces in wireless communication using solutions based on ML in the wireless communication system, and provides an architecture, a procedure, a method and the like for using an ML solution in a wireless communication system, and by designing the architecture, the procedure, the method, and the like to apply the ML algorithm in the wireless communication system, such that an improved ML method compared with traditional existing methods may be successfully used and implemented in the communication system and further improve transmission performance of the wireless communication system.

Therefore, in the present disclosure, according to the characteristics of the wireless communication system, possible stages and states of the UE and the base station regarding the use of the ML method, when applying an ML method in an air interface, are disclosed herein. Based on this, in the present disclosure, the procedure and behavior performed by the UE and the base station in different states when using the ML method in the wireless communication system are disclosed, including the procedure of the communication between the UE and the base station for this purpose, and some content that defines the communication. Further, in the present disclosure, the relationship between the different states of the UE and the base station when using the ML method in the wireless communication system and the transition procedure between the different states are disclosed. In addition, key performance indicators to measure ML algorithms and models in different situations are disclosed herein in combination with the different stages. The present disclosure also takes into account limitations of hardware and complexity of network protocol designs, utilizes the characteristics of wireless communication systems and the characteristics of ML algorithms that may be executed, to design the architecture, procedure, method, and the like used by the entire ML method.

### Stages

The present disclosure discloses a method for application and configuration of an ML algorithm and model in a wireless communication system, including defining states and stages of the wireless communication system with respect to the use of ML algorithm and model. In different states, the information exchange procedure implemented for this purpose in the wireless communication system, and the respective behaviors of the UE and the base station; and a relationship between different stages and internal transition procedures of the state for wireless communication systems.

When using the ML algorithm and model in the wireless communication system to implement one or several tasks of an air interface in communication transmission, the wireless communication system may be in any one of the five stages. The five stages include five stages, i.e.:
Initial stage: When the wireless communication system uses the ML algorithm and model to solve the problems of the existing air interface, the UE and the base station are in an initial stage.
Activation stage: When the wireless communication system decides to execute the ML algorithm and model, the UE and the base station are in a stage to activate the ML algorithm
Execution stage: When data or signaling information in the wireless communication system is transmitted and exchanged, the UE and the base station are in a stage to execute the corresponding ML algorithm and model.
Reconfiguration stage: When the ML algorithm and model are executed in the wireless communication system, the UE and base station are in a stage in which the configuration of the ML algorithm and model needs to be adjusted and reconfigured.
Finalization stage: When the wireless communication system decides to stop executing or to not execute the ML algorithm and model, the UE and the base station are in a stage to terminate running of the ML algorithm and model as well as related information exchange.

In the foregoing five stages, according to different specific situations, devices in the wireless communication system need to perform different procedures respectively, and in each procedure, the UE and the base station respectively perform different procedures and operations to use one or more specific ML-based algorithms and models to implement one or several tasks of the air interface in the communication transmission.

Specifically, tasks of the air interface in communication transmission include but are not limited to one or more of:
compression, feedback and reconstruction of channel state information;
prediction of the channel state information;
positioning of the UE;
beam management of the base station and the UE;
reference signal recovery and channel estimation of the base station and the UE, and
nonlinear compensation of a power amplifier.

### Initial Stage

Specifically, when a network side in the wireless communication system decides to use the ML-based algorithm and model to implement one or several tasks of the air interface in communication transmission, the base station transmits corresponding signals, and the wireless communication system enters into the initial stage. In this initial stage, the steps performed by the UE and the base station may include, but are not limited to, one or more of the following considerations.
The base station transmits signaling to the UE, requesting the UE to report information on the ML algorithm and model of the UE.
The signaling has different states, such as 00, 01, etc. The different states of the signaling may indicate a requirement of the base station for specific related information reported by the UE, a reporting method of the UE, and a reporting period of the UE.
After the UE receives the signaling, in case no further relevant signals are received from the base station, the UE may report according to the received signaling.
The UE reports the relevant information on the UE according to the reporting mode indicated by the signaling; and
The UE performs periodic, semi-static or aperiodic reporting of information on the UE according to the signaling.
After receiving the signaling, the UE reports information on the UE, including current state information and device capability information, wherein the specific reported information is correspondingly reported according to the different states of the received signaling.

The reported device capability information of the UE, including but is not limited to supported ML algorithm computation, computation speed and latency of the algorithm, computation throughput and latency of a typical ML model, and supported task or function implemented by ML-based algorithm and model, and the like.

The reported current state information of the UE includes, but is not limited to: a current computing load of the UE, a remaining available power, a current service or traffic type of the user, a wireless channel state or evaluation of the user, and preference setting information of the UE, and the like.

The base station transmits signaling to the UE requesting that the UE stop reporting information on the ML algorithm and model of the UE, such that the UE terminates all relevant information reporting in the initial stage after receiving the signaling.

### Activation Stage

Specifically, when a network side in the wireless communication system decides to activate the ML-based algorithm and model based on the current wireless network state, network device information and the information reported by the UE, so as to implement one or several tasks or functions of the air interface in communication transmission, the wireless communication system transfers to the activation stage. In this activation stage, the steps performed by the UE and the base station may include, but are not limited to, one or more of.
The base station transmits signaling to the UE, notifying the UE to start activating the ML algorithm and model during the communication procedure to implement one or several tasks or functions of the air interface in the communication transmission, where:
   different states of the signaling indicate which one or several tasks or functions start to use the ML algorithm and model to be implemented in the wireless communication system; and
   different states of the signaling indicate key performance indicators required by the ML algorithm and model.
The base station transmits signaling to the UE, notifying the UE of a degree of participation of the UE in each task or function upon starting to use the ML algorithm and model to implement one or several tasks or functions of the air interface in communication transmission, wherein the degree of participation of the UE may be divided into the following types:
   an ML algorithm and model implemented entirely by the UE, and
   an ML algorithm and model implemented jointly by the UE and the base station.
The base station transmits signaling to the UE, notifying the UE that, upon starting to use the ML algorithm and model to implement one or several tasks or functions of the air interface in communication transmission, an information exchange request of the UE and base station for each task or function, which may be divided into the following levels:
   the UE and the base station do not need to exchange relevant information;
   the UE and the base station conduct a one-time instant exchange of related information;
   the UE and the base station conduct aperiodic instant exchange of relevant information according to requirements; and
   the UE and the base station perform periodic instant exchange of related information.
The base station transmits signaling to the UE, notifying the UE of transmission mode of the information required to be exchanged for each task or function upon starting to use the ML algorithm and model to implement one or several tasks or functions of the air interface in communication transmission, which may be:
   first related information for transferring the ML algorithm and model, with the UE and the base station only needing to perform through signaling; and
   second related information for transferring an ML algorithm and model, where the UE and the base station need perform through signaling and a data channel.
The base station transmits information to the UE. notifying the UE of use of information on configuration the ML algorithm and model, including but not limited to one or more of:
   the base station transmits signaling to the UE, notifying the UE that the ML algorithm and model used by the UE is configured by one of preset algorithms and models; and
   the base station transmits signaling and data information to the UE, transmitting to the UE that a specific model structure and model parameter of the ML algorithm and model used by the UE
After the UE receives from the base station information notifying that the UE starts to use the ML algorithm and model to implement one or several tasks or functions of the air interface in the communication transmission, the UE activates the corresponding ML algorithm and model according to the state indicated by the signaling, and report information on the ML algorithm and model to the base station after activation, with the information including one or more of:
   a model structure, a parameter configuration, and the like of the ML algorithm and model; and
   key performance indicators of the algorithm of the ML algorithm and model, and the like.

### Execution Stage

When the ML-based algorithm and model are used in the wireless communication system to implement one or several tasks or functions of the air interface in the communication transmission, the wireless communication system transfers to the execution stage. In this execution stage, the steps performed by the UE and the base station may include, but are not limited to, one or more of:
the base station transmits signaling to the UE, requesting the UE to report state information of the UE, wherein the signaling may have different states of different state signaling to indicate one or more of the following:
   the content that the user needs to report, including at least one of the following:
   state information of the UE, including but not limited to: a current computing load of the UE, a remaining available power, a current service or traffic type of the user, a wireless channel status or evaluation of the user, and preference setting information of the UE, and the like;
   key performance indicators of the ML algorithm and model being executed by the UE;
   (collection of) data samples collected by the UE about the currently used ML algorithm and model; and
   the request for suspending or update of the ML algorithm and model used by the UE.
The frequency and/or period that the UE needs to report, including periodic, semi-static, or aperiodic reporting of related information.

After the UE receives the signaling sent by the base station, the UE reports state information (e.g., instant state information) on the UE, wherein information on the UE is reported according to the different states of the received signaling, the information on the UE may include, but is not limited to, one or more of:
o the state information of the UE, including but not limited to: a current computing load of the UE, a remaining available power, a current service or traffic type of the user, a wireless channel status or evaluation of the user, and preference setting information of the UE, and the like;
o key performance indicators of the ML algorithm and model being executed by the UE;
o collection of data samples by the UE about the currently used ML algorithm and model; and
o the request for suspending or update of the ML algorithm and model used by the UE.

The base station transmits a suspending signaling to the UE, requesting the UE to suspend the currently used ML algorithm and model, wherein different state indications of the signaling indicate the ML algorithm and model that require to be suspended, and their corresponding tasks or functions.

After receiving the suspending signaling, the UE suspends the ML algorithm and model corresponding to the signaling, and uses a non-ML method to perform the task or function, while maintaining the existing exchange of relevant information.

When use of the ML algorithm and model is suspended, according to the current situation, the base station determines to transmit to the UE a signaling indicating recovery of the function of using the ML algorithm and model to implement the channel state information feedback. After receiving the signaling, the user continues to use the ML algorithm and model so as to implement the function of channel state information feedback.

### Reconfiguration Stage

When using the ML-based algorithm and model in a wireless communication system to implement one or more tasks or functions of the air interface in communication transmission, the base station transmits a signal to the UE, requesting to adjust or update the ML algorithm and model in use, the wireless communication system transfers to the reconfiguration stage. In this reconfiguration stage, the steps performed by the UE and the base station may include, but are not limited to, one or more of the following.

The UE evaluates performance of the ML algorithm and model currently used by itself, or decides whether an update of the ML algorithm and model currently used by a certain task or function of the UE is required based on instant data samples collected by the UE during the execution stage, and if the update is required, the UE transmits information to the base station, wherein the information includes one or more of:
o an ML algorithm and model used by one or more tasks or functions that the UE recommends to update; and
o a configuration and preference of the ML algorithm and model recommended to be updated.

The base station receives from the UE a signal to recommend an update of the ML algorithm and model currently used by a certain task or function of the UE, wherein the configuration and preference of the updated ML algorithm and model may include one or more of:
a model structure of the ML algorithm and model;
a model parameter weight of the ML algorithm and model;
an input data format or a preference for the ML algorithm and model; and
performance indicator requirements for the ML algorithm and model.

The base station, according to evaluations of performance of the ML algorithm and model currently used by itself, or according to key performance indicators reported by the UE in the execution stage, decides whether an update to the ML algorithm and model currently used by the UE for a certain task or function is required, and if the update is required, the base station transmits a signal to the UE, wherein the signal includes one or more of:
an ML algorithm and model used by one or more tasks or functions of the UE that need to be updated; and
a configuration and preference of the updated ML algorithm and model.

The UE receives from the base station a signaling for updating the ML algorithm and model currently used by the UE for a certain task or function, wherein the configuration and preference of the updated ML algorithm and model may include one or more of:
o a model structure of the ML algorithm and model;
o a model parameter weight of the ML algorithm and model;
o an input data format or a preference for the ML algorithm and model; and
o key performance indicator requirements for the ML algorithm and model.

After the UE receives from the base station a signal for updating the ML algorithm and model currently used for a certain task or function of the UE, the UE updates the currently used ML algorithm and model within the required time according to the content contained in the signal, wherein the required time depends on the transmission mode of the signal received by the UE from the base station, including but not limited to transmission modes such as physical layer channels, media access control (MAC) layer channels, and radio resource control layer channels.

### Finalization Stage

When using the ML-based algorithm and model in a wireless communication system to implement one or several tasks or functions of the air interface in communication transmission, the base station transmits a signal to the UE, requesting the UE to terminate the ML algorithm and model currently in use, and terminating the exchange of related information, the wireless communication system transfers to the finalization stage. During this finalization stage, the steps performed by the UE and the base station may include, but are not limited to, one or more of the following.

The base station transmits signaling to the UE, requesting the UE to stop the currently used ML algorithm and model, and to the exchange of related information, with different states of signaling indicating to stop using the task or function corresponding to the ML algorithm and model.

The base station transmits signaling to the UE, requesting the UE to partially stop or completely terminate all currently used ML algorithms and models, and partially stop or completely terminate all exchange of related information.

After receiving the signaling to partially stop or completely terminate, the UE partially stops or completely terminates the ML algorithm and model corresponding to the signaling in use, partially stops or completely terminates the exchange of related data information, and switches to use a non-ML method to perform the task or function.

### Transition Between States and Among Stages

When the wireless communication system does not use the ML algorithm and model to implement one or several tasks or functions of air interfaces in communication transmission, the wireless communication system is in a non-ML state. When the wireless communication system uses the ML algorithm and model to implement one or several tasks or functions of air interfaces in communication transmission, the wireless communication system is in the ML state. For each task or function, the wireless communication system in the ML state may be in any one of the above five stages of its lifecycle.

When the wireless communication system may be in the non-ML state or any one of the above five stages in the ML state, the base station transmits signaling to the UE to indicate that the wireless communication system may transition from the current stage to another stage.

Specifically, when the wireless communication system is in a non-ML state, the base station transmits signaling to the UE, requesting the UE to report information on the ML algorithm and model of the UE, and the UE reports information on the ML algorithm and model based on the signaling received from the base station. At this time, the wireless communication system transitions into the initial stage.

When the wireless communication system is in the initial stage, the base station transmits a signaling to the UE, requesting the UE to stop reporting information on the ML algorithm and model of the UE, and the UE, based on the signaling received from the base station, terminates reporting of all relevant information in the initial stage. At this time, the wireless communication system transitions into the finalization stage.

When the wireless communication system is in the initial stage, the base station transmits signaling to the UE, requesting to start using the ML algorithm and model to implement one or several tasks or functions of air interfaces in the communication transmission during the communication procedure. At this time, the wireless communication system transitions into the activation stage, and the UE configures and activates the corresponding ML algorithm and the model as required based on the signaling received from the base station.

When the wireless communication system is in the activation stage, the activated ML algorithm and model start to be executed so as to realize one or several tasks or functions of the air interface in the communication transmission. At this time, the wireless communication system transitions into the execution stage. During the execution stage, information is exchanged between the base station and the UE to ensure the performance indicators of the task or function.

When the wireless communication system is in the execution stage, the base station transmits a signal to the UE to adjust or update the ML algorithm and model used by the UE. At this time, the wireless communication system transitions into the reconfiguration stage. During the reconfiguration stage, the base station reconfigures the ML model and algorithm used on the UE according to the situation.

When the wireless communication system is in the reconfiguration stage, the base station transmits a signal to the UE to request to adjust or update the ML algorithm and model being used by the UE, and after the update, the wireless communication system uses the updated ML algorithm and model. The wireless communication system returns to the execution stage at this time.

When the wireless communication system is in the execution stage, the base station transmits signaling to the UE, requesting the UE to stop using the ML algorithm and model and the exchange of the related information, and the UE prepares to stop the corresponding ML algorithm and model and the exchange of related information based on the signaling received from the base station. At this time, the wireless communication system transitions into the finalization stage.

When the wireless communication system is in the finalization stage, the base station and the UE stop the use of the ML algorithm and model and the exchange of related information, and the base station and the UE use the non-ML method to perform tasks or functions of the air interface in wireless communication transmission. The wireless communication system transitions into the non-ML state at this time.

The present disclosure has at least the following advantages over conventional systems and methods. The present disclosure provides a new application and configuration method of an ML-based algorithm and model on in a wireless communication system. Specifically, when the wireless communication system uses the ML algorithm and model and is in the ML state, the method divides into a plurality (e.g., five) of interrelated stages, thereby clearly implementing and terminating the ML algorithm and model according to the different situations. In addition, for each stage, the present disclosure clarifies possible behaviors of the base station and the UE, specifies information contained in the communication transmission between the base station and the UE, and provides necessary conditions for the use of the ML algorithm and model. Finally, the present disclosure also clarifies the relationship between different states and stages, as well as the relationship and process of internal transition among different states and stages, and builds a basic framework required for using the ML algorithm and model. Therefore, on the basis of fully considering the existing wireless communication system, the present disclosure provides a method for applying and configuring an ML algorithm and model in the wireless communication system in combination with the characteristics and requirements of the ML-based algorithm and model. The method provides a reasonable procedure, a complete framework and necessary information exchange content in the air interface, so as to realize application and configuration of the ML algorithm and model in the wireless communication system, and realizing or completing functions or tasks of the air interface in the wireless communication using the ML algorithm and model improves communication effectiveness and reliability of the wireless communication system.

The following example describes the completion framework, procedure and lifecycle of the wireless communication system implementing the method of applying and configuring the ML model of the present disclosure.

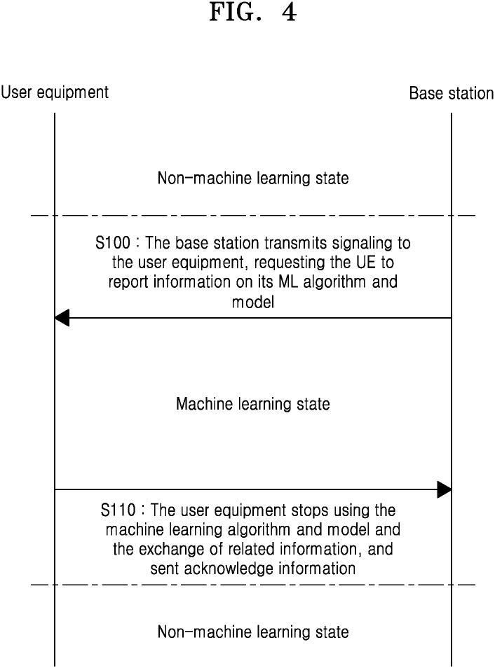

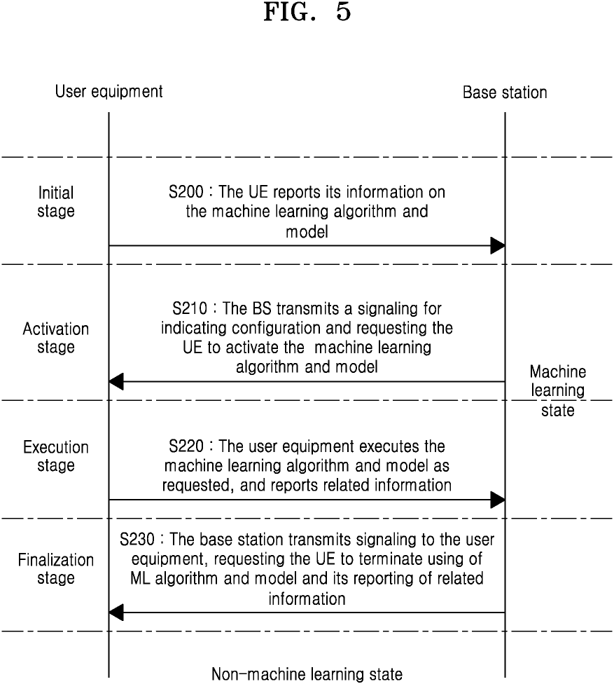

The wireless communication system realizes one of the tasks or functions in the air interface through the traditional non-ML method, i.e., the channel state information feedback from the UE to the base station. Firstly, the network side in the wireless communication system decides to use the ML-based algorithm and model to achieve this task, that is, the UE feeds back channel information to the base station, with the base station transmitting corresponding signal, and the wireless communication system transitions from the non-ML state to the initial stage in the machine learning state based on the signal, as shown in FIGS. 4 and 5.

FIG. 4 illustrates switching between an ML learning state and a non-ML by a UE and a base station in a wireless communication system according to an embodiment. FIG. 5 illustrates a lifecycle of a UE and a base station in an ML state in a wireless communication system according to an embodiment. In step S100 of FIG. 4, the base station transmits signaling to the UE requesting that the UE report information on the ML algorithm and model of the UE, for example:
the base station requests the UE to report related information on an uplink control channel;
the base station requests the UE to report related information aperiodically (one-time reporting); and/or
the base station requires the UE to report the supported ML task, the computing capability of the ML, the current state and preference of the UE, the current service or traffic type of the UE, and the like.

In step S200 of FIG. 5, based on the signaling received from the base station, the UE reports information on the ML algorithm and model at one time on the uplink control channel. For example:
the UE reports the supported ML task, such as ML-based UE channel state information feedback;
the UE reports a computation speed and latency of a supported standard convolutional neural network;
the UE reports a current remaining power and a preference setting; and/or
the UE reports a current main service or traffic type, such as streaming media and a game service.

Based on the information reported by the UE, the base station decides to activate and start channel state information feedback of the UE based on the ML algorithm and model, as shown in FIG. 5. At this time, the behavior procedure of the base station and the UE in the wireless communication system is as follows. Specifically:

in step S210 of FIG. 5, the base station transmits a signal to the UE to activate the ML algorithm and model of the UE, and the signal may include one or more of:
the ML algorithm and model being used to implement the channel state information feedback function of the UE;
use of the ML algorithm and model being implemented jointly by the UE and the base station;
the UE and the base station performing periodic instant exchange of related information;
the UE and the base station exchanging information on the ML algorithm and model through signaling and a data channel; and
performance indicator requirements during the transmission procedure (such as a downlink transmission block error rate less than a threshold, e.g., less than 2%).

The base station transmits information to the UE to notify the UE of a specific situation of using the ML algorithm and model, for example:
the base station transmits the signaling and data information to the UE, notifying the UE of a model structure and parameter specifically used by the UE when the ML algorithm and model used by the UE are used for channel state information feedback; and/or
the base station transmits the signaling and data information to the UE, notifying the UE of a size of the bit stream fed back by the UE when the machine learning algorithm and model used by the UE are used for channel state information feedback.

The UE reports information to the base station based on the received activation signaling of the ML algorithm and model, for example:
when the ML algorithm and model used by the UE are used for channel state information feedback, the model structure and parameter specifically used by the UE; and/or
key performance indicators when the UE uses the ML algorithm and model, including information such as computation latency and calculation accuracy.

After the UE reports the relevant activation information, the configured ML model is used to start executing a task of channel state information feedback.

After the communication system activates the ML algorithm and model, the communication system may transfer to the execution stage in the ML state, as shown in FIG. 5. At this time, the UE uses the configured UE ML algorithm and model to feed back the specified bit stream, and after receiving the feedback bit stream, the base station uses the specified ML algorithm and model to reconstruct the channel state information to complete subsequent tasks in communication of the base station. In this procedure, the behavior procedure of the base station and the UE in the wireless communication system may specifically include, for example:
the base station transmits a signal to the UE, requesting the UE to transmit information on the currently activated ML algorithm and model, which may include, e.g., one or more of the following depending on the situation:
a mode of reporting information, e.g., periodic reporting; and
a content of the reported information: evaluation by the UE of the currently used ML algorithm and model, the current computing load of the UE, the current available power of the UE, a current preference setting of the UE, and the like.

In step S220 of FIG. 5, the UE reports the corresponding information of the UE based on the signaling received from the base station, which may specifically include one or more of:
the current computing load of the UE, the current available power of the UE, a current preference setting of the UE;
information on the performance requirements of the ML algorithm and model during the execution of the UE, such as model accuracy, computation latency, and the like; and
a sample set of current full channel state information collected by the UE.

When the UE finds that the current ML algorithm and the model are not suitable, the UE may transmit a request to the base station according to the situation, for example:
when the UE considers that the current ML algorithm and model are not suitable for use according to the current equipment situation and/or algorithm performance evaluation, the UE transmits a request to the base station to suspend the use of the ML algorithm and model to implement channel state information feedback; and/or
when the UE considers that the configuration of the current ML algorithm and model need to be changed according to the current equipment situation and/or algorithm performance evaluation, the UE transmits a request to the base station to adjust/update the ML algorithm and model to implement channel state information feedback.

The base station makes a decision based on the current state, such as the information fed back by the UE, the current computing load of the base station, and the wireless channel propagation environment, and the like, and transmits a suspend signaling to the UE, requesting the UE to suspend the currently used ML algorithm and model; and based on the received signaling, the user suspends use of the ML algorithm and model to implement channel state information feedback function, and maintains the existing related information exchange.

When use of the ML algorithm and model is suspended, the base station determines, according to the current situation, to transmit to the UE the indication of recovery of using the ML algorithm and model to implement the channel state information feedback function, and the user continues to use the ML algorithm and model to implement the function of channel state information feedback, based on the signaling received from the base station.

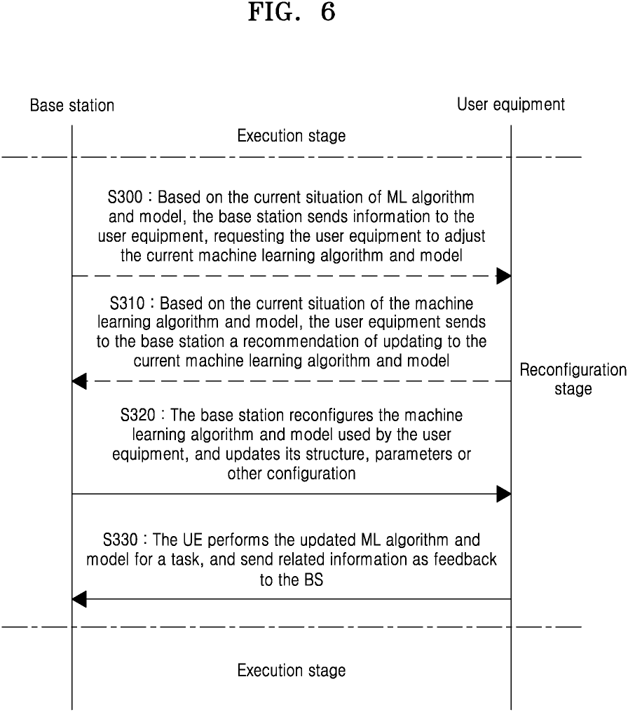

When using the ML-based algorithm and model to implement the function of channel state information feedback, the base station makes a judgment according to the situation, and transmits the signal to the UE, requesting to adjust or update of the ML algorithm and model in use. At this time, the wireless communication system transfer to the reconfiguration stage, as shown in FIG. 6.

FIG. 6 illustrates updating and reconfiguration of an ML algorithm and model in an ML state for a UE and a base station in a wireless communication system according to an embodiment.

In the reconfiguration stage illustrated in FIG. 6, the behavior procedure of the UE and the base station may include, but is not limited to, one or more of steps S300 to S330 of FIG. 6.

In step S300 of FIG. 6, the base station transmits information to the UE, requesting to reconfigure the ML algorithm and model for performing the channel state information feedback function, wherein the information includes at least one of:
requesting the UE to recommend an updated ML algorithm and model; and
requesting the UE to provide key performance indicator evaluations of the updated ML algorithm and model.

In step S310 of FIG. 6, the UE reports relevant information based on the received update request from the base station, wherein the relevant information may include, for example:
an ML algorithm and model used by the channel state information feedback function, recommended by the UE to be updated; and
a configuration and a preference of the machine learning algorithm and model recommended by the UE to be updated, including, e.g., a model structure and a model parameter.

In step S320 of FIG. 6, after receiving from the UE a recommendation for updating the ML algorithm and the model being used by the UE, the base station transmits a request to update the ML algorithm and model being used by the UE, including one or more of:
a model structure of the ML algorithm and model;
a model parameter weight of the ML algorithm and model;
an input data format or a preference for the ML algorithm and model; and
performance indicator requirements for the ML algorithm and model.

The UE updates the currently used ML algorithm and model within the required time based on content contained in the update request received from the base station, wherein the required time depends on the transmission mode of the signal received by the UE from the base station (such as an update command sent through the MAC layer channel).

In step S330 of FIG. 6, based on the signal received from the base station for updating the ML algorithm and model currently used for a certain task or function of the UE, the UE updates the configuration and preference of the ML algorithm and model within the required time, and after the update is completed, reports to the base station, key performance indicators of the reconfigured ML algorithm and model, including but not limited to:
computational latency of the ML algorithm and model evaluated by the UE, and/or
accuracy of the ML algorithm and model evaluated by the UE.

When using the ML-based algorithm and model to implement the function of channel state information feedback in the wireless communication system, the base station transmits a signal to the UE to request the UE to terminate the ML algorithm and model currently being used, and to terminate the exchange of the relevant information, and the wireless communication system transfers to the finalization stage of the ML state, as shown in FIGS. 4 and 5. In this finalization stage, a behavior procedure of the UE and the base station may include, but is not limited to, one or more of:

In S230 of FIG. 5, the base station transmits the signaling to the UE, requesting the UE to partially stop or completely terminate the currently used ML algorithm and model, and partially stop or completely terminate the exchange of the related information, for example, the signaling indicates that the ML algorithm and model to be partially stopped or completely terminated are the ML algorithm and model for realizing channel state information feedback, and indicates to partially stop or completely terminate the exchange of information related thereto.

The UE partially stops or completely terminates the ML algorithm and model in use based on the received signaling of partial stopping or completely termination, partially stops or completely terminates the interaction of related data and information, and switches to use a non-ML method to execute the function of channel state information feedback.

In step S110 of FIG. 4, the UE stops using the ML algorithm and model, stops information exchange related to the ML, and transmits acknowledgement of information to the base station. At this time, the wireless communication system transitions from a ML state to a non-ML state.

The above performance indicator requirements may be at least one of:
the requirement of transport block error rate reaches a certain threshold;
an accuracy and/or precision and/or recall of the ML algorithm and model reaches a certain threshold; and
a processing time and/or computational latency of the ML algorithm and model reaches a certain threshold.

When the above wireless communication system uses the ML algorithm and model to implement the function of channel state information feedback in the air interface, the wireless communication system transitions from a non-ML state to an ML state, during which multiple (e.g., five) different stages of the lifecycle may be experienced. When the wireless communication system stops using an ML-based algorithm and model to implement channel state information feedback, the wireless communication system returns to the non-ML state.

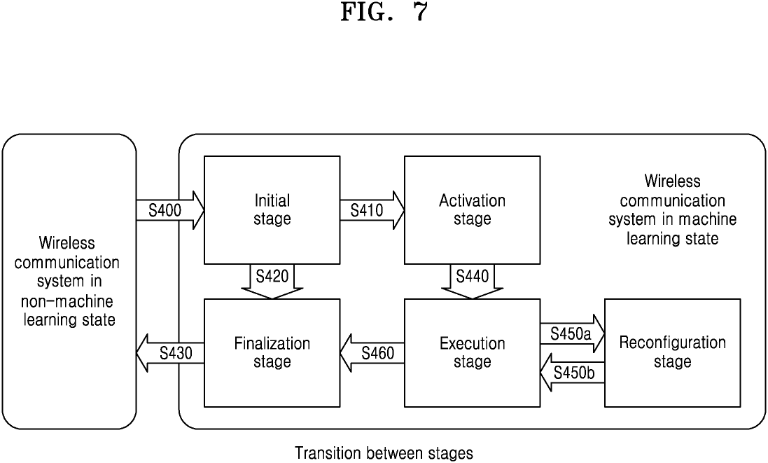

The wireless communication system may transition from a current state or stage to another state or stage, as shown in FIG. 7.

FIG. 7 illustrates an internal transition relationship between states and among stages of an ML state and a non-ML state according to an embodiment.

As illustrated in step S400 of FIG. 7, when the wireless communication system is in a non-ML state, the base station transmits the signaling to the UE, requesting the use of ML algorithm and model to realize the function of channel state information feedback, and to exchange relevant information. At this time, the wireless communication system transitions into the initial stage of the ML state.

In step S420 of FIG. 7, when the wireless communication system is in the initial stage, the base station transmits the signaling to the UE, requesting the UE to stop the exchange of relevant information upon the ML algorithm and the model realizes the function of channel state information feedback, and at this time, the wireless communication system transitions into the non-ML state.

In step S410 of FIG. 7, when the wireless communication system is in the initial stage, the base station transmits the signaling to the UE, requesting to start using the ML algorithm and model in the communication procedure to realize the function of the channel state information feedback of an air interface in the communication transmission. At this time, the wireless communication system transitions into the activation stage.

In step S440 of FIG. 7, when the wireless communication system is in the activation stage, the activated ML algorithm and model start to be executed, so as to realize the function of channel state information feedback and exchange of relevant information, and the wireless communication system transitions into the execution stage at this time.

In step S450a of FIG. 7, when the wireless communication system is in the execution stage, the base station transmits a signal to the UE, requesting to adjust or update the ML algorithm and model in use, and the wireless communication system transitions into the reconfiguration stage at this time.

In step S450b of FIG. 7, when the wireless communication system is in the reconfiguration stage, the UE and the base station have completed the reconfiguration of the corresponding ML algorithm and model, and after updating the ML algorithm and model, the wireless communication system uses the updated ML algorithm and model. The wireless communication system returns to the execution stage at this time.

In step S460 of FIG. 7, when the wireless communication system is in the execution stage, the base station transmits the signaling to the UE, requesting the UE to stop using the ML algorithm and model and the exchange of related information, and the wireless communication system transitions into the finalization stage at this time.

In step S430 of FIG. 7, when the wireless communication system is at the finalization stage, the base station and the UE stop using the ML algorithm and model and performing related information exchange, and use a non-ML method to perform a task or function of an air interface in wireless communication transmission. The communication system transitions into a non-ML state.

The above embodiments describe, by way of illustration, a new application and configuration method of based on an ML algorithm and model in a wireless communication system. Specifically, the above embodiments may divide the lifecycle, in which the wireless communication system uses the ML algorithm and model and is in the ML state, into a plurality of interrelated stages (although the lifecycle described in the above embodiments includes five stages, it is not limited to this, and may also include other numbers of stages), so as to clearly implement and terminate the ML algorithm and model according to different states. Meanwhile, for each stage, the above embodiment clarifies the behaviors or procedures occurred at the base station and the UE, which exemplifies the information contained in the communication between the base station and the UE. Finally, the above embodiment also clarifies the relationship and flow of the internal transition among different states and stages, thus describing the basic framework required for using the ML algorithm and model constructed by the present disclosure. Therefore, on the basis of fully considering the existing wireless communication system, the present disclosure provides a method for applying and configuring an ML algorithm and model in the wireless communication system in combination with the characteristics and requirements based on the ML algorithm and model. The method provides a reasonable procedure, a complete framework and necessary information exchange content in air interfaces, so as to realize application and configuration of the ML algorithm and model in the wireless communication system, and by realizing or completing functions or tasks of the air interface in the wireless communication transmission using the ML algorithm and model, thereby improving communication effectiveness and reliability of the wireless communication system.

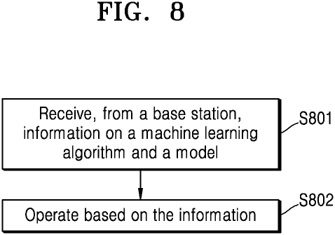

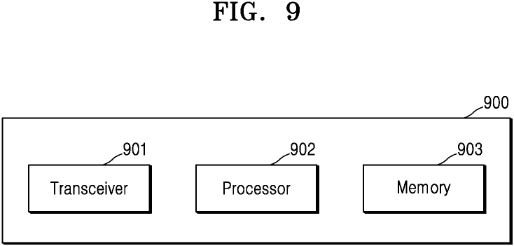

FIG. 8 illustrates a method performed by the UE according to an embodiment. The method illustrated in FIG. 8 is an example in which the UE (e.g., UE 900 of FIG. 9) performs operations associated with an ML algorithm and model.

As shown in step S810 of FIG. 8, the UE receives information on an ML algorithm and model from the base station.

In step S820 of FIG. 8, the UE perform at least one operation based on the received information.

The at least one operation based on the information in the step S820 may include at least one of:
a) the information on the ML algorithm and model includes first information; the at least one operation based on the information on the ML algorithm and model includes:
   based on the first information, reporting information on an ML algorithm and model used by the UE to the base station;
b) the information on the ML algorithm and model includes second information; the at least one operation based on the information on the ML algorithm and model includes:
   based on the second information, reporting information on an acknowledgement of an activation of the ML algorithm and model to the base station;
c) the information on the ML algorithm and model includes third information; the at least one operation based on the information on the ML algorithm and model includes:
   based on the third information, reporting information on an acknowledgement of an update of the ML algorithm and model to the base station;
d) the information on the ML algorithm and model includes fourth information; the at least one operation based on the information on the ML algorithm and model includes:
   based on the fourth information, stopping one or more partial ML algorithms and models or terminating all of one or more ML algorithms and models;
e) the information on the ML algorithm and model includes fifth information; the at least one operation based on the information on the ML algorithm and model includes,
   based on the fifth information, reporting information on reconfiguring the ML algorithm and model to the base station;
f) the information on the ML algorithm and model includes sixth information, the at least one operation based on the information on the ML algorithm and model includes:
   based on the sixth information, reporting, by the UE, contents indicated by the sixth information to the base station;
g) the information on the ML algorithm and model includes seventh information; the at least one operation based on the information on the ML algorithm and model includes,
   based on the seventh information, suspending the ML algorithm and model; and
h) the information on the ML algorithm and model includes eighth information; the at least one operation based on the information on the ML algorithm and model includes:
   based on the eighth information, resuming the ML algorithm and model.

The first information may include, but is not limited to, at least one of:
information for indicating periodical, semi-statical or aperiodical report by the UE;
information for indicating a task performed through ML;
information for indicating reporting of capabilities of processing (such as capabilities of computing) the ML algorithm and model;
information for indicating report of a status and/or a preference setting of the UE; and
information for indicating report of a service or traffic type of the UE.

The information on the ML algorithm and model of the UE may include, but is not limited to, at least one of:
information on a task performed through ML;
information on capabilities of processing the ML algorithm and model;
information on a status and/or a preference setting of the UE; and
information on a service or traffic type of the UE.

The information on the capabilities of processing the ML algorithm and model may be the computation speed and/or latency of neural network supported by the UE. In an example, the information on the status and/or the preference setting of the UE may be a remaining battery level and/or preference of the UE.

The second information may include, but is not limited to, at least one of:
information for indicating a task to be implemented by using the ML algorithm and model;
information for indicating a wireless communication device that executes the ML algorithm and model;
information for indicating a periodic setting of information transmission between the UE and the base station;
information for indicating that the information on the ML algorithm and model is transferred through a control channel and/or a data channel;
information for indicating information on a performance indicator of transmission; and
information for indicating a model configuration and/or a transmission configuration of the ML algorithm and model.

The information on the acknowledgement of the activation of the ML algorithm and model may include, but is not limited to, at least one of:
information on a model configuration of the ML algorithm and model; and
information on performance of the machine learning algorithm and model.

The information for indicating a model configuration and/or a transmission configuration of the ML algorithm and model may include, but is not limited to, at least one of:
information on a model structure and/or parameter; and
information on a transmission capability.

The third information may include, but is not limited to, at least one of:
information for indicating a model structure of the ML algorithm and model,
information for indicating a model parameter of the ML algorithm and model;
information for indicating an input and/or output data format and/or a preference of the ML algorithm and model; and
information for indicating a performance indicator of the ML algorithm and model.

The information on the acknowledgement of the update of the ML algorithm and model may include, but is not limited to information on performance of the updated ML algorithm and model.

The information on performance of the updated ML algorithm and model may include, but is not limited to, at least one of:
information on a computational latency of the ML algorithm and model; and
information on accuracy and/or precision and/or recall of the ML algorithm and model.

The fifth information may include, but is not limited to, at least one of:
information for indicating reconfiguration of the ML algorithm and model; and
information for indicating a performance requirement for reconfiguring the ML algorithm and model.

The information on reconfiguring the ML algorithm and model may include, but is not limited to, at least one of:
information on recommended updated ML algorithm and model; and
information on a structure and/or parameter and/or preference of the recommended updated machine learning algorithm and model.

The method further includes, based on the fourth information, partially stopping or completely terminating transmission of related data information on the ML algorithm and model, and transmitting to the base station information on an acknowledgement of the partially stop or completely terminating.

The sixth information may include, but is not limited to, at least one of:
information on a reporting content of the UE; and
information on a frequency and/or period of the reporting of the UE.

The information on the UE may include, but is not limited to, at least one of:
information on a state of the UE;
information on performance of the ML algorithm and model;
information on a data sample of the ML algorithm and model; and
information on a suspending and/or update requirement for the ML algorithm and model.

The task performed through ML (or the ML task) may include, but is not limited to, at least one of:
compression, feedback and/or reconstruction of channel state information;
prediction of the channel state information;
positioning of the UE;
beam management of the base station and/or the UE;
reference signal recovery and/or channel estimation for the base station and/or the UE; and
nonlinear compensation of a power amplifier.

Although the present disclosure illustrates that the information on the ML algorithm and model includes the first information to the eighth information and the respective information reported by the UE, it is not limited thereto. Example methods performed by the UE may include additional aspects, such as any single aspect or any combination of aspects in conjunction with one or more other procedures described elsewhere herein.

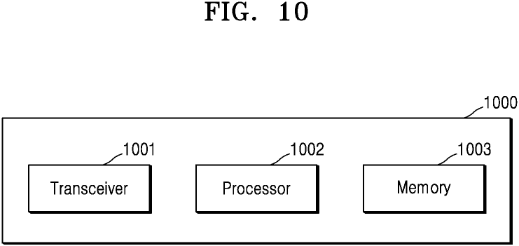

A method performed by a base station (e.g., a base station 1000 in FIG. 10) in a wireless communication system according to an embodiment of the present disclosure is described below. The method may include transmitting information on a ML algorithm and model to a UE.

In an embodiment of the disclosure, the method may further include:
a) the information on the ML algorithm and model includes first information; receiving from the UE, information on the ML algorithm and model of the UE, reported by the UE based on the first information,
b) the information on the ML algorithm and model includes second information; receiving from the UE, information on an acknowledgement of an activation of the ML algorithm and model, reported by the UE based on the second information;
c) the information on the ML algorithm and model includes third information, receiving from the UE, information on an acknowledgement of an update of the ML algorithm and model, reported by the UE based on the third information;
d) the information on the ML algorithm and model includes fourth information; stopping one or more partial ML algorithms and models or terminating all of one or more ML algorithms and models;
e) the information on the ML algorithm and model includes fifth information, receiving from the UE, information on reconfiguring the ML algorithm and model, reported by the UE based on the fifth information;
f) the information on the ML algorithm and model includes sixth information; receiving from the UE, information on the UE, reported by the UE based on the sixth information;
g) the information on the ML algorithm and model includes seventh information; receiving from the UE, information on an acknowledgement of suspending the ML algorithm and model, reported by the UE based on the seventh information; and
h) the information on the ML algorithm and model includes eighth information; receiving from the UE, information on an acknowledgement of a resuming the ML algorithm and model, reported by the UE based on the eighth information.

The first information may include, but is not limited to, at least one of:
information for indicating periodical, semi-statical or aperiodical report by the UE;
information for indicating a task performed through ML;
information for indicating reporting of capabilities of processing the ML algorithm and model;
information for indicating report of a status and/or a preference setting of the UE; and
information for indicating report of a service or traffic type of the UE.

The information on the ML algorithm and model of the UE may include, but is not limited to, at least one of the following:
information on a task performed through ML;
information on capabilities of processing the ML algorithm and model;
information on a status and/or a preference setting of the UE; and
information on a service or traffic type of the UE.

The second information may include, but is not limited to, at least one of:
information for indicating a task to be implemented using the ML algorithm and model;
information for indicating a wireless communication device that executes the ML algorithm and model;
information for indicating a periodic setting of information transmission between the UE and the base station;
information for indicating that the information on the ML algorithm and model is transferred through a control channel and/or a data channel;
information for indicating information on a performance indicator of transmission; and
information for indicating a model configuration and/or a transmission configuration of the ML algorithm and model.

The information on the acknowledgement of the activation of the ML algorithm and model may include, but is not limited to, at least one of:
information on a model configuration of the ML algorithm and model; and
information on performance of the ML algorithm and model.

The information for indicating a model configuration and/or a transmission configuration of the ML algorithm and model may include, but is not limited to, at least one of:
information on a model structure and/or parameter; and
information on a transmission capability.

The third information may include, but is not limited to, at least one of:
information for indicating a model structure of the ML algorithm and model;
information for indicating a model parameter of the ML algorithm and model;
information for indicating an input and/or output data format and/or a preference of the ML algorithm and model; and
information for indicating a performance indicator of the ML algorithm and model.

The information on the acknowledgement of the update of the ML algorithm and model may include, but is not limited to, information on performance of the updated ML algorithm and model.

The information on performance of the updated ML algorithm and model may include, but is not limited to, at least one of:
information on a computational latency of the ML algorithm and model; and
information on accuracy and/or precision and/or recall of the ML algorithm and model.

The fifth information may include, but is not limited to, at least one of:
information for indicating reconfiguration of the ML algorithm and model; and
information for indicating a performance requirement for reconfiguring the ML algorithm and model.

The information on reconfiguring the ML algorithm and model may include, but is not limited to, at least one of:
information on recommended updated ML algorithm and model; and
information on a structure and/or parameter and/or preference of the recommended updated ML algorithm and model.

The method may further include, based on the fourth information, receiving from the UE, information on an acknowledgement of stopping one or more partial ML, algorithms and models or terminating all of one or more ML algorithms and models, reported by the UE based on the fourth information, and partially stopping or completely terminating transmission of related data information on the ML algorithm and model.

The sixth information may include, but is not limited to, at least one of
information on a reporting content of the UE; and
information on a frequency and/or period of the reporting of the UE.

The information on the UE may include, but is not limited to, at least one of:
information on a state of the UE;
information on performance of the ML algorithm and model;
information on a data sample of the ML algorithm and model; and
information on a suspending and/or update requirement for the ML algorithm and model.

The task performed through ML (or the ML task) may include, but is not limited to, at least one of:
compression, feedback and/or reconstruction of channel state information,
prediction of the channel state information,
positioning of the UE;
beam management of the base station and/or the UE;
reference signal recovery and/or channel estimation for the base station and/or the UE; and
nonlinear compensation of a power amplifier.

Although the present disclosure illustrates that the information on the ML, algorithm and model includes the first to eighth information, and the information reported by the UE that is received from the UE, it is not limited thereto. Example methods performed by the base station may include additional aspects, such as any single aspect or any combination of aspects in conjunction with one or more other procedures described elsewhere herein.

FIG. 9 illustrates components of a UE in accordance with an embodiment.

Referring to FIG. 9, the UE 900 includes a transceiver 901, a processor 902, and a memory 903. Under the control of a controller 902, which may be implemented as one or more processors, the UE 900 may be configured to perform the related operations performed by the UE in the methods described above. Although the transceiver 901, the processor 902 and the memory 903 are shown as separate entities, they may be embodied as a single entity, such as a single chip. The transceiver 901, the processor 902, and the memory 903 may be electrically connected or coupled with each other. The transceiver 901 may transmit and receive signals to and from other network entities, such as a node, which may be for example a base station, a relay node, and the like, and/or another UE and/or the like. In some implementations, the transceiver 901 may be omitted. In this case, the processor 902 may be configured to execute instructions (including computer programs) stored in the memory 903 to control the overall operation of the UE 900, so as to implement the operations in the flow of the above methods. In some implementations, the memory 903 may be omitted. In this case, the operations of the UE in the flow of the above methods may also be implemented.

FIG. 10 illustrates components of a base station in accordance with an embodiment.

Referring to FIG. 10, the base station 1000 includes a transceiver 1001, a processor 1002, and a memory 1003. Under the control of a controller 1002 (which may be implemented as one or more processors), the base station 1000 may be configured to perform the related operations performed by the base station in the methods described above. Although the transceiver 1001, the processor 1002 and the memory 1003 are shown as separate entities, they may be embodied as a single entity, such as a single chip The transceiver 1001, the processor 1002, and the memory 1003 may be electrically connected or coupled with each other. The transceiver 1001 may transmit and receive signals to and from other network entities, such as another node, which may be for example a base station, a relay node, and the like, and/or a UE and/or the like. In some implementations, the transceiver 1001 may be omitted. In this case, the processor 1002 may be configured to execute instructions (including computer programs) stored in the memory 1003 to control the overall operation of the base station 1000, so as to implement the operations in the flow of the above methods. In some implementations, the memory 1003 may be omitted. In this case, the operations of the base station in the flow of the above methods may also be implemented.

While the disclosure has been shown and described with reference to various embodiments thereof, it will be understood by those of ordinary skill in the art that various changes in form and details may be made therein without departing from the spirit and scope of the disclosure as defined by the following claims and their equivalents.

What is claimed is:

1. A method performed by a user equipment (UE) in a wireless communication system, the method comprising:
receiving information on a machine learning algorithm and model of the UE; and
performing at least one operation based on the received information.

2. The method of claim 1, wherein the received information comprises at least one of first information, second information, third information, fourth information, fifth information, sixth information, seventh information, and eighth information, and
wherein the at least one operation comprises at least one of:
based on the first information, reporting information on a machine learning algorithm and model used by the UE to the base station;
based on the second information, reporting information on an acknowledgement of an activation of the machine learning algorithm and model of the UE to the base station;
based on the third information, reporting information on an acknowledgement of an update of the machine learning algorithm and model of the UE to the base station;
based on the fourth information, stopping one or more partial machine learning algorithms and models or terminating at least one machine learning algorithm and model;
based on the fifth information, reporting information on reconfiguring the machine learning algorithm and model of the UE to the base station;
based on the sixth information, reporting contents indicated by the sixth information to the base station;
based on the seventh information, suspending the machine learning algorithm and model; and
based on the eighth information, resuming the machine learning algorithm and model.

3. The method of claim 2, wherein the first information comprises at least one of:
information for indicating at least one of a periodical report, a semi-statical report or an aperiodical report by the UE;
information for indicating a task performed through machine learning;
information for indicating reporting of capabilities of processing the machine learning algorithm and model;
information for indicating reporting at least one of a status and a preference setting of the UE; and
information for indicating reporting a service type or a traffic type of the UE.

4. The method of claim 2, wherein the information on the machine learning algorithm and model of the UE comprises at least one of:
information on a task performed through machine learning;
information on capabilities of processing the machine learning algorithm and model;
information on at least one of a status and a preference setting of the UE; and
information on a service type or a traffic type of the UE.

5. The method of claim 2, wherein the second information comprises at least one of:
information for indicating a task to be implemented using the machine learning algorithm and model;
information for a wireless communication device that executes the machine learning algorithm and model;
information for indicating a periodic setting of information transmission between the UE and the base station;
information for indicating that the information on the machine learning algorithm and model is transferred through at least one of a control channel and a data channel;
information for indicating information on performance indicator transmission; and
information for indicating at least one of a model configuration and a transmission configuration of the machine learning algorithm and model.

6. The method of claim 2, wherein the information on the acknowledgement of the activation of the machine learning algorithm and model comprises at least one of:
information on a model configuration of the machine learning algorithm and model; and
information on performance of the machine learning algorithm and model.

7. The method of claim 5, wherein the information for indicating the at least one of the model configuration and the transmission configuration of the machine learning algorithm and model comprises at least one of:
information on at least one of a model structure and a model parameter; and
information on a transmission capability.

8. The method of claim 2, wherein the third information comprises at least one of:
information for indicating a model structure of the machine learning algorithm and model;
information for indicating a model parameter of the machine learning algorithm and model;
information for indicating at least one of an input data format, an output data format and a preference of the machine learning algorithm and model; and
information for indicating a performance indicator of the machine learning algorithm and model.

9. The method of claim 2, wherein the information on the acknowledgement of the update of the machine learning algorithm and model comprises information on performance of the updated machine learning algorithm and model.

10. The method of claim 9, wherein the information on performance of the updated machine learning algorithm and model comprises at least one of:
information on a computational latency of the machine learning algorithm and model; and
information on at least one of accuracy, precision and recall of the machine learning algorithm and model.

11. The method of claim 2, wherein the fifth information comprises at least one of:
information for indicating reconfiguration of the machine learning algorithm and model; and
information for indicating a performance requirement for reconfiguring the machine learning algorithm and model.

12. The method of claim 2, wherein the information on reconfiguring the machine learning algorithm and model comprises at least one of:
information on a recommended updated machine learning algorithm and model; and
information on at least one of a model structure, a model parameter, and a preference of the recommended updated machine learning algorithm and model.

13. The method of claim 2, further comprising:
based on the fourth information, partially stopping or completely terminating transmission of related data information on the machine learning algorithm and model, and transmitting to the base station information on an acknowledgement of partially stopping or completely terminating.

14. The method of claim 2, wherein the sixth information comprises at least one of:
information on the contents; and
information on at least one of a frequency and a period of reporting the contents.

15. The method of claim 2, wherein the contents comprise at least one of:
information on a state of the UE;
information on performance of the machine learning algorithm and model;
information on a data sample of the machine learning algorithm and model; and
information on at least one of a suspending requirement and an update requirement for the machine learning algorithm and model.

16. The method of claim 3, wherein the task performed through machine learning comprises at least one of:
compression of channel state information;
feedback of the channel state information;
reconstruction of the channel state information;
prediction of the channel state information;
positioning of the UE;
beam management of the base station;
beam management of the UE;
reference signal recovery for at least one of the base station and the UE;
channel estimation for at least one of the base station and the UE; and
nonlinear compensation of a power amplifier.

17. A method performed by a base station in a wireless communication system, the method comprising:
transmitting information on a machine learning algorithm and model to a user equipment (UE); and
receiving a report regarding the machine learning algorithm and model from the UE.

18. The method of claim 17, wherein the transmitted information comprises at least one of first information, second information, third information, fourth information, fifth information, sixth information, seventh information, and eighth information,
wherein receiving the report comprises:
based on the first information, receiving information on a machine learning algorithm and model used by the UE;
based on the second information, receiving information on an acknowledgement of an activation of the machine learning algorithm and model of the UE;
based on the third information, receiving information on an acknowledgement of an update of the machine learning algorithm and model of the UE;
based on the fourth information, receiving information on an acknowledgement of stopping one or more partial machine learning algorithms and models or terminating at least one machine learning algorithm and model;
based on the fifth information, receiving information on reconfiguring the machine learning algorithm and model of the UE;
based on the sixth information, receiving contents indicated by the sixth information;
based on the seventh information, receiving information on an acknowledgement of suspending the machine learning algorithm and model; and
based on the eighth information, receiving information on an acknowledgement of resuming the machine learning algorithm and model.

19. A user equipment (UE) in a wireless communication system, the UE comprising:
a transceiver; and
a processor, coupled to the transceiver and configured to:
receive information on a machine learning algorithm and model of the UE; and
perform at least one operation based on the received information.

20. The UE of claim 19, wherein the received information comprises at least one of first information, second information, third information, fourth information, fifth information, sixth information, seventh information, and eighth information, and
wherein the at least one operation comprises at least one of:
based on the first information, reporting information on a machine learning algorithm and model used by the UE to the base station;
based on the second information, reporting information on an acknowledgement of an activation of the machine learning algorithm and model of the UE to the base station;
based on the third information, reporting information on an acknowledgement of an update of the machine learning algorithm and model of the UE to the base station;
based on the fourth information, stopping one or more partial machine learning algorithms and models or terminating at least one machine learning algorithm and model;
based on the fifth information, reporting information on reconfiguring the machine learning algorithm and model of the UE to the base station;
based on the sixth information, reporting contents indicated by the sixth information to the base station;
based on the seventh information, suspending the machine learning algorithm and model; and
based on the eighth information, resuming the machine learning algorithm and model.
